(19) United States
(12) Patent Application Publication
(10) Pub. No.: US 2012/0255179 A1
(43) Pub. Date: Oct. 11, 2012

(54) APPARATUS AND METHODS FOR LOCKING KNIFE BLADES

(76) Inventor: Stanley MOIZIS, North Delta (CA)

(21) Appl. No.: 13/082,816

(22) Filed: Apr. 8, 2011

(51) Int. Cl. B26B 1/08

(52) U.S. Cl. 30/162; 30/164

(57) ABSTRACT

Apparatus for locking an out the front knife having a blade assembly moveable with respect to a handle assembly between an extended position and a retracted position comprises a first guide member in the handle assembly, the first guide member having a first longitudinal slot defined therein, the first longitudinal slot having first front locking features at a forward portion thereof and first rear locking features at a rearward portion thereof, and a locking member rotatably coupled to a tang portion of the blade assembly, the locking member having at least one locking protrusion thereon, wherein the locking member is rotatable between a sliding position wherein the locking protrusion is aligned with the first longitudinal slot and a locking position wherein the locking protrusion is not aligned with the first longitudinal slot. The blade assembly is lockable in the extended or retracted position by rotating the locking member to the locking position such that the locking protrusion engages the first front or rear locking features.

### TECHNICAL FIELD

The invention relates to knives with retractable blades. Certain embodiments provide new and improved methods and apparatus for locking retractable knife blades.

### BACKGROUND

Knives with retractable blades that slide longitudinally with respect to the handle are often referred to as “out-the-front” or “OTF” knives. OTF knives typically include locking mechanisms for holding the blade in the retracted position or the extended position. However, some prior art locking mechanisms may allow the blade to wobble when in the extended position, or may not be sufficient to resist strong forces to prevent the blade from moving out of the extended position. Likewise, some prior art OTF knives are also prone to “misfires” wherein the locking mechanisms fail to lock the blade in either the extended or retracted position.

Various attempts have been made to provide improved locking and release mechanisms for OTF knives. For example, US Patent Application Publication No. 2007/0175045 to McHenry et al. discloses an OTF automatic knife which incorporates dual locking and release mechanisms that define a three-point blade-handle interconnection when the blade is locked in the open position.

The inventor has determined a need for improved OTF knives, and for apparatus and methods for locking OTF knives.

### SUMMARY

This summary is provided to introduce a selection of representative concepts and aspects of the invention in a simplified form that are further described below in the description. This summary is not intended to identify key features or essential features of the claimed subject matter, nor is it intended to be used in any way that would limit the scope of the claimed subject matter.

One aspect provides apparatus for locking an out the front knife having a blade assembly moveable with respect to a handle assembly between an extended position and a retracted position. The apparatus comprises a first guide member in the handle assembly, the first guide member having a first longitudinal slot defined therein, the first longitudinal slot having first front locking features at a forward portion thereof and first rear locking features at a rearward portion thereof, and a locking member rotatably coupled to a tang portion of the blade assembly, the locking member having at least one locking protrusion thereon, wherein the locking member is rotatable between a sliding position wherein the locking protrusion is aligned with the first longitudinal slot and a locking position wherein the locking protrusion is not aligned with the first longitudinal slot. The blade assembly is lockable in the extended position by rotating the locking member to the locking position such that the locking protrusion engages the first front locking features, and the blade assembly is lockable in the retracted position by rotating the locking member to the locking position such that the locking protrusion engages the rear locking features.

Another aspect provides a method for locking an out the front knife having a blade assembly moveable with respect to a handle assembly between an extended position and a retracted position, the blade assembly comprising blade at a front thereof and a tang portion at a rear thereof. The method comprises providing a first guide member in the handle assembly, the first guide member having a first longitudinal slot defined therein, the first longitudinal slot having first front locking features at a forward portion thereof and first rear locking features at a rearward portion thereof, providing a locking member rotatably coupled to a tang portion of the blade assembly, the locking member having at least one locking protrusion thereon, wherein the locking member is rotatable between a sliding position wherein the locking protrusion is aligned with the first longitudinal slot and a locking position wherein the locking protrusion is not aligned with the first longitudinal slot, when the blade assembly is in the extended position, rotating the locking member to the locking position such that the locking protrusion engages the first front locking features to lock the blade assembly in the extended position, and, when the blade assembly is in the retracted position, rotating the locking member to the locking position such that the locking protrusion engages the rear locking features to lock the blade assembly in the retracted position.

Another aspect provides a knife comprising a handle assembly comprising an upper guide member and a lower guide member oriented generally parallel to each other and separated by a first distance, each of the upper and lower guide members having a longitudinal slot defined therein, the upper and lower slots being generally aligned with each other, and each of the upper and lower slots having front locking features at a forward portion thereof and rear locking features at a rear portion thereof, and, a blade assembly comprising a blade having one ore more cutting edges at a forward portion thereof and a tang portion at a rear portion thereof, the blade assembly moveable inwardly and outwardly with respect to the handle assembly between an extended position wherein the one or more cutting edges are exposed and a retracted position wherein the one or more cutting edges are within the handle assembly, the tang portion having a thickness no greater than the first distance and comprising one or more tang protrusions extending from opposite sides thereof such that the tang portion is slidably received between the upper and lower guide members with the tang protrusions extending into the slots, the blade assembly comprising a locking member rotatably received in an aperture in the tang portion, the locking member comprising a body having a thickness no greater than the first distance and one or more locking protrusions extending from opposite sides thereof, the locking member rotatable between a sliding position wherein the locking protrusions are aligned with the tang protrusions and the slots and a locking position wherein the locking protrusions are not aligned with the tang protrusions and the slots. When the blade assembly is in the extended position the locking protrusions are adjacent to the front locking features such that the locking member is rotatable to engage the front locking features with the locking protrusions to lock the blade assembly in the extended position. When the blade assembly is in the retracted position the locking protrusions are adjacent to the rear locking features such that the locking member is rotatable to engage the rear locking features with the locking protrusions to lock the blade assembly in the retracted position.

In addition to the exemplary aspects and embodiments described above, further aspects and embodiments will become apparent by reference to the drawings and by study of the following detailed descriptions.

### BRIEF DESCRIPTION OF DRAWINGS

The accompanying drawings show non limiting example embodiments.

FIG. 1 shows a knife according to one embodiment in an extended position.

FIG. 2 shows the knife of FIG. 1 in a retracted position.

FIG. 3 is a side view of the knife of FIG. 2.

FIG. 4 is an exploded view of the knife of FIG. 2.

FIG. 4A is an enlarged view of the area indicated in circle A of FIG. 4.

FIG. 5 is a top view of the upper guide member of FIG. 4 in isolation.

FIGS. 5A and 5B illustrate an example of how the locking member of the FIG. 4 embodiment may be rotated to disengage from the locking features by a lever.

FIG. 6 is a bottom view of the lower guide member of FIG. 4 with the spring arms attached thereto.

FIGS. 6A and 6B illustrate an example how the locking member of the FIG. 4 embodiment may rotated to engage the locking features by a spring arm.

FIG. 7 shows the locking member of FIG. 4 in isolation.

FIG. 8 shows one of the levers of FIG. 4 in isolation.

FIG. 9 is an exploded view of a knife according to another embodiment.

FIG. 10 shows the upper guide member of FIG. 9 in isolation.

FIGS. 10A and 10B show upper guide members according to other embodiments.

FIG. 11 shows the lower guide member of FIG. 9 in isolation.

FIGS. 11A and 11B show lower guide members according to other embodiments.

FIG. 12 shows the locking member of FIG. 9 in isolation.

FIG. 12A shows the locking member of FIG. 9 rotated 180 degrees with respect to the view of FIG. 12.

FIG. 12B shows a locking member according to another embodiment.

FIG. 13 shows a lever of the FIG. 9 embodiment in isolation.

FIGS. 13A and 13B show levers according to other embodiments.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

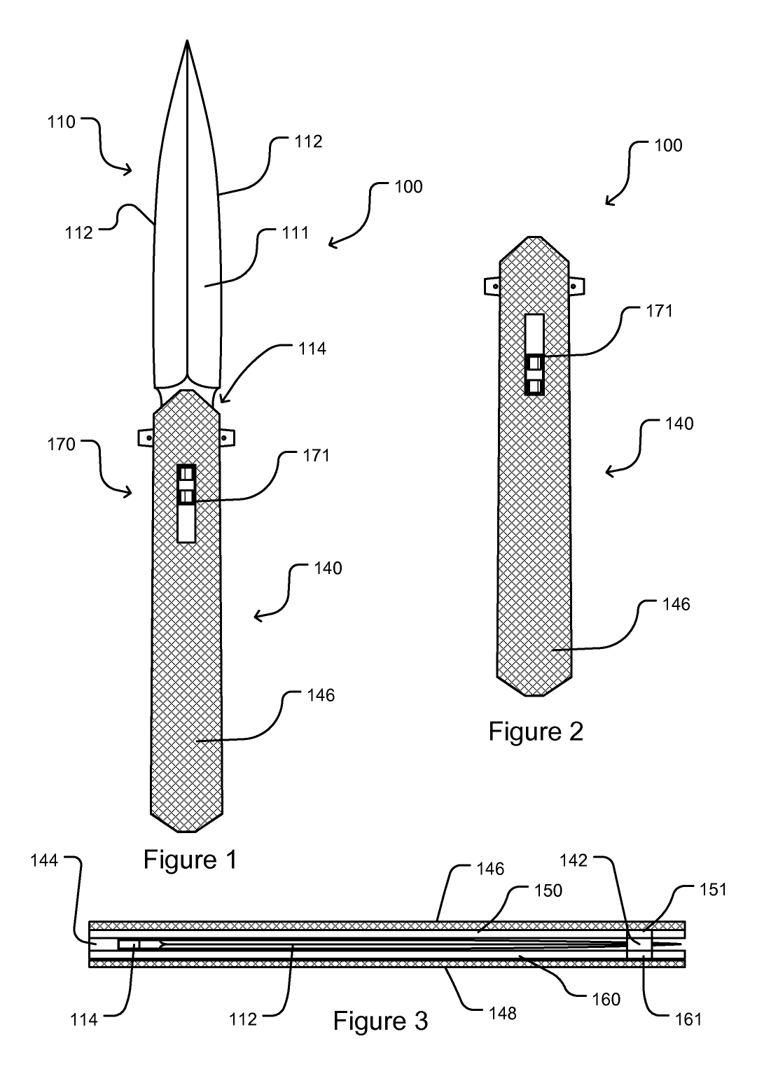

FIGS. 1 to 4 show a knife 100 according to an example embodiment. Knife 100 comprises a blade assembly 110 and a handle assembly 140. Knife 100 is moveable between an extended position wherein cutting edges 112 of blade 111 are exposed as shown in FIG. 1 and a retracted position wherein blade assembly 110 is within handle assembly 140 as shown in FIGS. 2 and 3. Knife 100 may be referred to as an “out-the-front” or “OTF” knife. Blade assembly 110 is moveable inwardly and outwardly with respect to handle assembly 140 by means of an actuating assembly 170 operable by a thumb block 171, as described below.

As used herein, the term “forward” and other similar terms refer to the direction toward the point of knife 100, and the term “rear” and similar terms refer to the opposite direction. Likewise, the term “top” and similar terms refer to the direction toward the side of knife 100 on which switch 171 is located, and the term “bottom” and similar terms refer to the opposite direction.

Handle assembly 140 comprises an upper guide member 150 and a lower guide member 160. Blade assembly 110 is slidingly received between upper and lower guide members 150 and 160. Handle assembly 140 also comprises side spacers 142 and a rear spacer 144 which provide separation between upper and lower guide members 150 and 160 such that blade assembly 110 may be received therebetween. Handle assembly 140 also comprises top and bottom covers 146 and 148. Covers 146 and 148 may have outer surfaces which are textured, shaped, coated, or otherwise adapted for gripping by a user.

Blade assembly 110 comprises a blade 111 having cutting edges 112 and a tang portion 114. A locking member 120 is rotatably coupled to tang portion 114. In the illustrated embodiment, tang portion 114 has a locking member aperture 116 defined therethrough which is shaped to rotatably receive locking member 120, as described below.

Upper and lower guide members 150 and 160 each comprise a pair of tabs 151 and 161 extending laterally outwardly therefrom near the fronts thereof. Side spacers 142 are positioned between side tabs 151 and 161, such that a gap between side spacers 142 may be as or almost as wide as handle assembly 140. This configuration in turn permits blade 111 to be as wide, or almost as wide, as handle assembly 140 (although blade 111 will typically be slightly narrower than handle assembly 140 such that cutting edges 112 are safely covered by handle assembly 140 when knife 100 is in the retracted position).

Tang portion 114 may also comprise a pair of opposed side portions 115 which are slightly wider apart than the gap between side spacers 142. Side portions 115 may be configured to abut side spacers 142 when knife 100 is in the extended position to provide additional points of contact, which may thereby improve the stability of blade assembly 110 with respect to handle assembly 140.

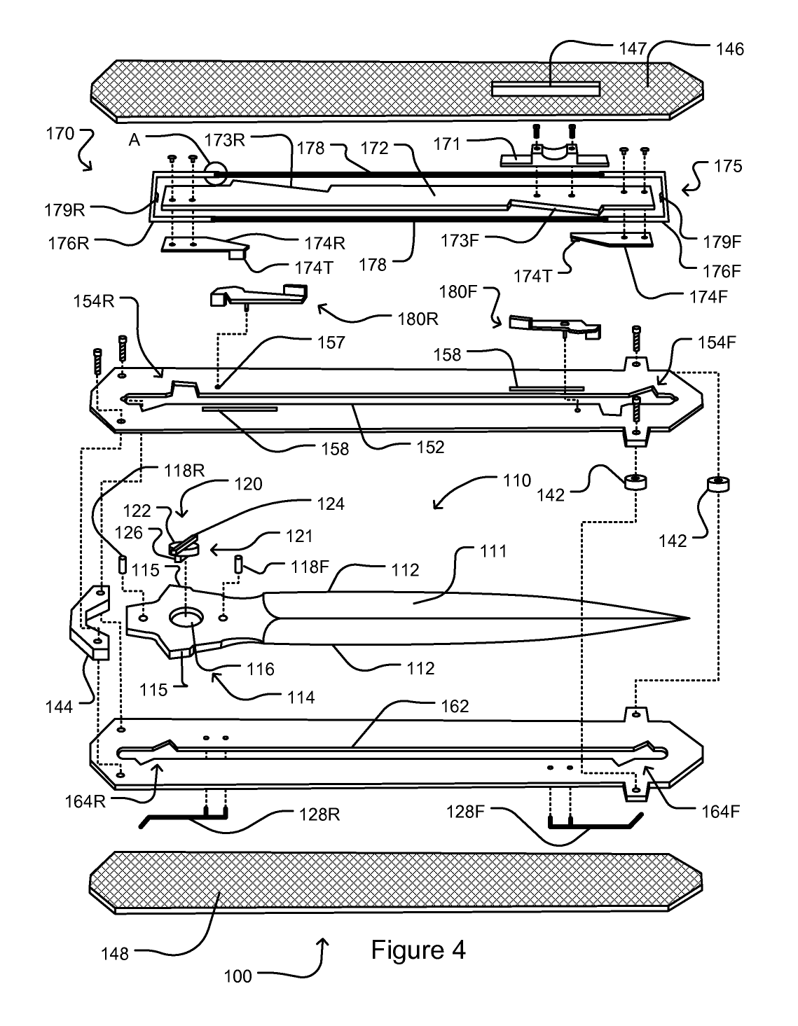

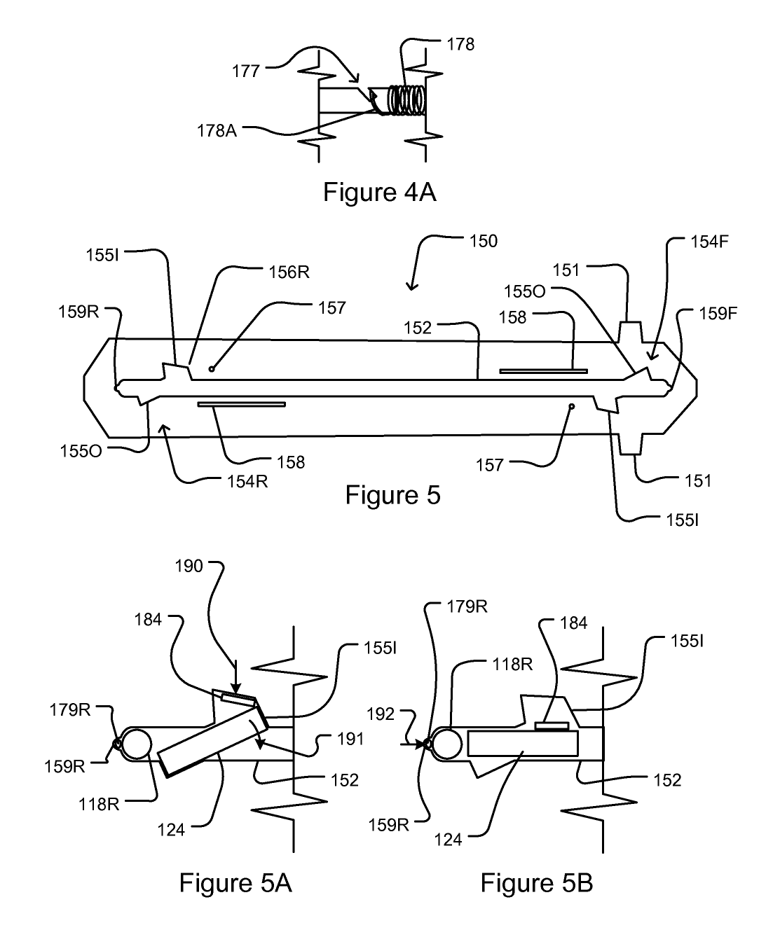

In the FIG. 4 embodiment, tang portion 114 also comprises a pair of tang protrusions on the top and bottom sides thereof which are slidingly received in slots 152 and 162 in upper and lower guide members 150 and 160, respectively, as described below. In the illustrated embodiment, such protrusions are provided by a front guide post 118F and a rear guide post 118R inserted through corresponding apertures in tang portion 114 in front and back of lock member aperture 116. However, it is to be understood that tang portion 114 may have different configurations in different embodiments. For example, two protrusions (one in front of and one behind the locking member) on top side of tang portion 114 are provided in the

FIG. 4 embodiment, as such protrusions permit movement of blade assembly 110 by actuating assembly 170, as described below, but tang portion 114 could have a different configuration if a different type of actuating assembly were employed. Also, the protrusions on the bottom side of tang portion 114 in the FIG. 4 embodiment provide additional stability to blade assembly 110, but are not required in all embodiments.

As best seen in FIG. 7, locking member 120 comprises a body 121 having a width substantially equal to or smaller than the width of tang portion 114, such that body 121 can slide between top and bottom guide members 150 and 160. Body 121 has at least one locking protrusion extending therefrom. In the illustrated embodiment, body 121 comprises a disk 122, and the locking protrusions comprise a top ridge 124 and a bottom ridge 126, but it is to be understood that body 121 and the locking protrusion(s) may take different forms. For example, in some embodiments locking protrusions may be provided on only the top side of body 121.

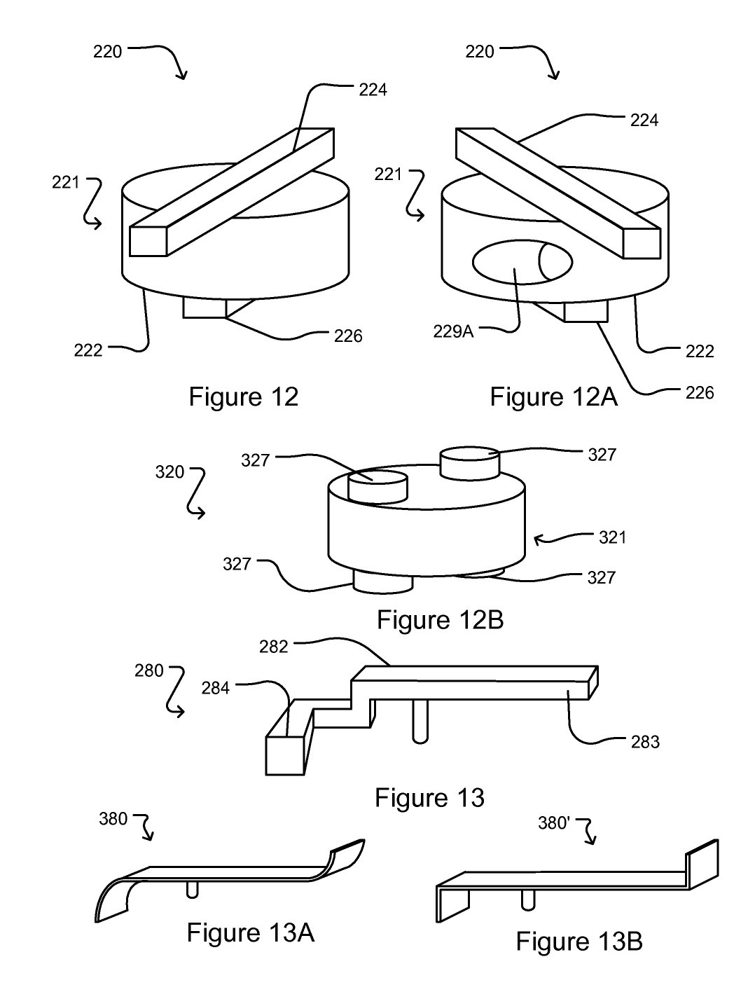

Instead of ridges 124 and 126, the locking protrusions may, for example, comprise a pair of posts (as shown, for example, in FIG. 12B) on opposite edges of each of the top and bottom sides of body 121. The locking protrusion(s) on the top side of body 121 may extend outwardly past the circumferential edge of disk 122 (as does top ridge 124, as best seen in

FIG. 7) in some embodiments to facilitate rotation of locking member 120, as discussed below, but this is not required. In some embodiments the locking protrusion(s) on the top side of body 121 may be flush with, or inward from, the circumferential edge of disk 122. The protrusion(s) on the bottom side of body 121 may extend downwardly below lower guide member 160 (as does bottom ridge 126) in some embodiments to be contacted by biasing members on the bottom of lower guide member 160, as described below, but this is not required. In some embodiments the protrusion(s) on the bottom side of body 121 may have different configurations, or may be omitted.

Upper guide member 150 comprises a slot 152 therein. Slot 152 is configured to slidingly receive protrusions on the top sides of tang portion 114 and lock member body 121 to allow blade assembly 110 to move between the extended position of FIG. 1 and the retracted position of FIG. 2. Likewise, lower guide member 160 comprises a slot 162 therein, which is configured to slidingly receive protrusions on the bottom sides of tang portion 114 and lock member body 121. Slots 152 and 162 may have the same widths in some embodiments, or may have different widths. Upper and lower guide members 150 and 160 also respectively comprise front locking features 154F and 164F at forward portions of slots 152 and 162 and rear locking features 154R and 164R a rearward portions of slots 152 and 162 in the illustrated embodiment. Front locking features 154F and 164F are configured to receive the locking protrusions on the top and bottom of body 121 (i.e. ridges 124 and 126 in the illustrated embodiment) respectively when knife 100 is in the extended position, as described below. Likewise, rear locking features 154R and 164R are configured to receive the protrusions on the top and bottom of body 121 (i.e. ridges 124 and 126 in the illustrated embodiment) respectively when knife 100 is in the retracted position, as described below.

In some embodiments, upper and lower guide members 150 and 160 may have different configurations. For example, in some embodiments more than one locking member may be provided in the tang portion and guide members 150 and 160 may comprise two or more slots. In some embodiments, locking protrusion(s) may be provided on only the top of the locking member, and lower guide member 160 may not have locking features. In some embodiments, the bottom sides of the locking member and the tang portion may be without protrusions and substantially flat, and lower guide member may also be substantially flat without any slot, or may be omitted entirely, with the bottom sides of the locking member and the tang portion sliding along other portions of the handle assembly.

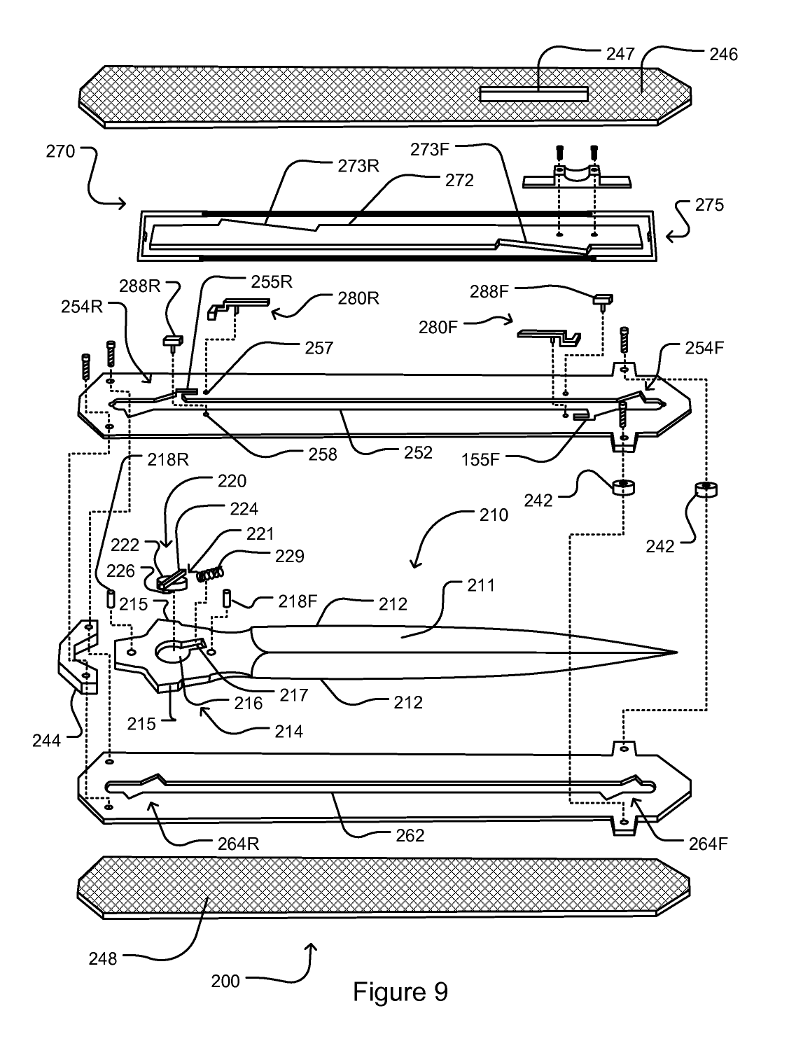

Locking member 120 is rotatable with respect to tang portion 114 between a sliding position wherein the protrusions of body 121 are substantially aligned with the protrusions of tang portion 114, and a locking position wherein the protrusions of body 121 are out of alignment with the protrusions of tang portion 114. When blade assembly 110 is in the retracted position or the extended position, locking member 120 is urged toward the locking position by one or more biasing members. In the FIG. 4 embodiment, bottom ridge 126 extends downwardly out of slot 162 and the biasing members comprise a forward spring arm 128F for rotating locking member 120 into the locking position when blade assembly 110 is in the extended position and a rear spring arm 128R for rotating locking member 120 into the locking position when blade assembly 110 is in the retracted position, as described further below. Forward and rear spring arms 128F and 128R may, for example, be attached to lower guide member 160 by a pair of posts extending into corresponding apertures in lower guide member 160, but it is to be understood that spring arms 128F and 128R may be attached in other ways. In other embodiments, biasing may be provided by different components. For example, in knife 200 of the FIG. 9 embodiment discussed below, biasing of locking member 220 is provided by a coil spring 229 received within a recess 217 in tang portion 214 adjacent aperture 216, and a corresponding recess 229A (see FIG. 12A) in body 221.

In the illustrated embodiment, when knife 100 is in the extended position, locking member 120 is aligned with front locking features 154F and 164F and front spring arm 128F bears against bottom ridge 126, which forces disk 122 to rotate such that ridges 124 and 126 are at an acute angle with respect to slots 152 and 162 and engaged with front locking features 154F and 164F, thereby preventing movement of blade assembly 110 with respect to handle assembly 140. Likewise, when knife 100 is in the retracted position, locking member 120 is aligned with rear locking features 154R and 164R and rear spring arm 128R bears against bottom ridge 126, which forces disk 122 to rotate such that ridges 124 and 126 are at an acute angle with respect to slots 152 and 162 and engaged with rear locking features 154R and 164R thereby prevent movement of blade assembly 110 with respect to handle assembly 140.

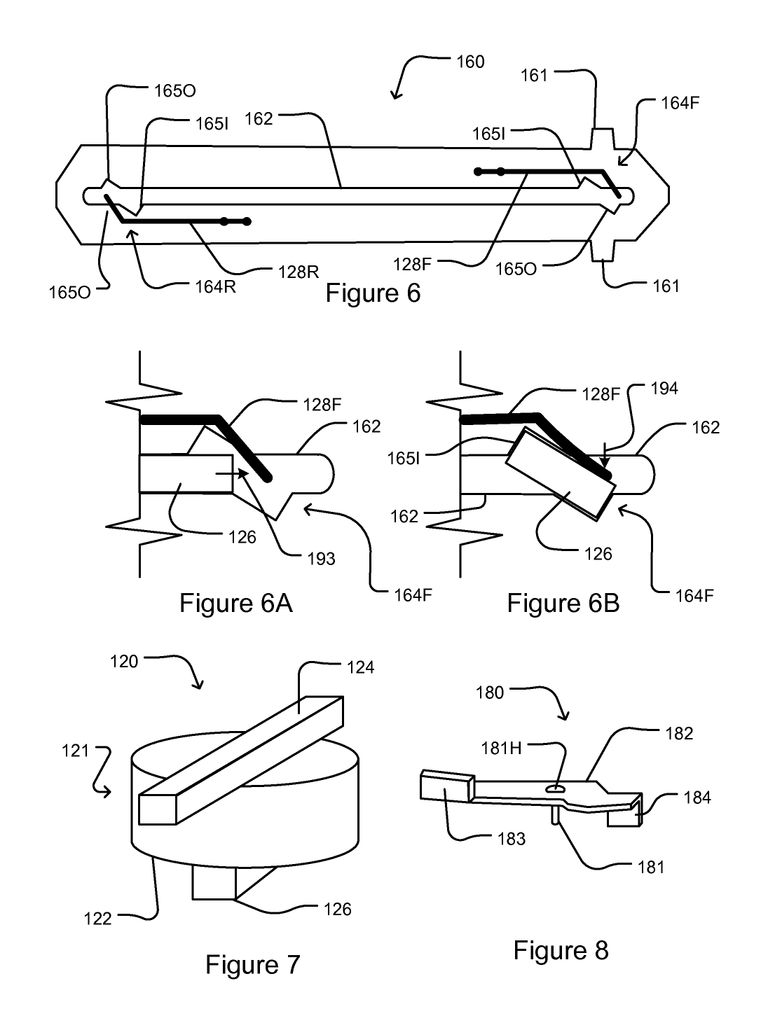

Front and rear locking features 154F and 154R of upper guide member 150 may be substantially similar in shape, with front locking features 154F rotated 180 degrees with respect to rear locking features 154R. Likewise, front and rear locking features 164F and 164R of lower guide member 160 may be substantially similar in shape, with front locking features 164F rotated 180 degrees with respect to rear locking features 164R. With reference to FIG. 5, in the illustrated embodiment front and rear locking features 154F and 154R of upper guide member 150 each comprise an inner cutout portion 1551 on one side of slot 152 and an outer cutout portion 1550 on the opposite side of slot 152, with inner cutout portions 1551 of front and rear locking features 154F and 154R on opposite sides of slot 152. Likewise, with reference to FIG. 6, in the illustrated embodiment front and rear locking features 164F and 164R of lower guide member 160 each comprise an inner cutout portion 1651 on one side of slot 162 and an outer cutout portion 1650 on the opposite side of slot 162, with inner cutout portions 1651 of front and rear locking features 164F and 164R on opposite sides of slot 162.

Locking features 154F, 154R, 164F and 164R in the illustrated embodiment are configured to accommodate ridges 124 and 126 when body 121 of locking member 120 is rotated. Ridges 124 and 126 are generally rectangular in shape, which in turn determines the shapes of locking features 154F, 154R, 164F and 164R. However, it is to be understood that the protrusions from body 121 could take different forms, such that locking features 154F, 154R, 164F and 164R may have different shapes in different embodiments.

Inner cutout portions 1551 of locking features 154F and 154R of upper guide member 150 may be larger than outer cutout portions 155O in some embodiments to accommodate levers 180F and 180R, respectively, as described below. A lever aperture 157 may provided adjacent to each inner cutout portion 1551 to facilitate pivotal coupling of levers 180F and 180R to upper guide member 150. A guide slot 158 may be provided on the opposite side of slot 152 from each lever aperture 157 to prevent lateral movement of a slide bar 172 with respect to guide member 150 and facilitate longitudinal movement of slide bar 172 as described below. In other embodiments, lateral movement of slide bar 172 with respect to guide member 150 may be prevented by other mechanisms. For example, in the FIG. 9 embodiment discussed below, stop blocks 288F and 288R are coupled to guide member 250 opposite levers 280F and 280R. Upper guide member 150 may also comprise tab recesses 159F and 159R at the front and rear ends of slot 152 to accommodate tabs 179F and 179R of a spring harness 175, as described below.

In the FIG. 4 embodiment, actuating assembly 170 comprises a thumb block 171 which protrudes through an aperture 147 in top cover 146. Thumb block 171 is connected (for example, by screws in the illustrated embodiment) to a slide bar 172, such that a user may push thumb block 171 back and forth to move slide bar 172 back and forth. Slide bar 172 comprises angled portions 173F and 173R which bear against corresponding portions of levers 180F and 180R, respectively, as slide bar 172 moves, as described below. Forward and rear slide bar guides 174F and 174R are attached (for example, by rivets in the illustrated embodiment) to the bottom of slide bar 172, and have downwardly extending tabs 174T which are slidingly received in guide slots 158.

A spring harness 175 is positioned around slide bar 172. Spring harness 175 comprises forward and rear U-shaped members 176F and 176R, the inner ends of which are coupled to each other by a pair of springs 178. As shown in FIG. 4A, springs 178 may be coupled to the ends of U-shaped members 176F and 176R by means of one or more bent coils 178A received in a slot 177 defined in each of the ends of U-shaped members 176F and 176R. Springs 178 may be coupled to U-shaped members 176F and 176R in other ways in other embodiments. U-shaped members 176F and 176R each have a downwardly extending tab 179F/179R at a central portion thereof configured to bear against posts 118F and 118R to move blade assembly 110 as described below.

As best seen in FIG. 8, each of levers 180F and 180R (generically referred to as lever 180, though they need not be identical) comprises a body 182 pivotally coupled to upper guide member 150 by a rivet 181 received in lever aperture 157. A head 181H of rivet 181 protrudes above body 182 of lever 180, such that slide bar 172 slides across head 181H rather than body 182 of lever 180, thereby reducing friction therebetween and allowing lever 180 to pivot freely. The inward end of lever 180 comprises an upwardly extending pushing portion 183 which is positioned to abut angled portion 173F/173R of slide bar 172, such that longitudinal movement of slide bar 172 forces lever 180 to rotate. The outward end of lever 180 comprises a downwardly extending pushing portion 184 which is positioned to abut top ridge 124 of locking member 120, such that when locking member 120 is in the locking position, rotation of lever 180 caused by movement of slide bar 172 in turn causes pushing portion 184 to push top ridge 124 into alignment with slot 152 and out of engagement with locking features 154F/154R.

The underside of top cover 146 is configured to accommodate slide bar 172, spring harness 175 and levers 180F and 180R (for example by providing recesses in the underside of top cover 146). Likewise, the top of bottom cover 148 is configured to accommodate spring arms 128F and 128R and any protrusion extending from locking member 120 out of slot 162. The peripheral edges of top and bottom covers 146 and 148 may respectively be configured to abut upper and lower guide members 150 and 160 to keep the components within relatively free from dust or other debris. Similarly, the edges of aperture 147 in top cover 146 may abut the base of thumb block 171 to prevent or reduce dust or other debris from entering handle assembly 140 through aperture 147.

Example operation of knife 100 as blade assembly 110 moves from the retracted position to the extended position will now be described. As best seen in FIG. 5A, when blade assembly 110 is in the retracted position, top ridge 124 of locking member 120 is rotated out of alignment with slot 152 to engage locking features 154R (likewise, bottom ridge 126 of locking member 120 is rotated out of alignment with slot 162 to engage locking features 164R). Tab 179R of spring harness 175 is held in tab recess 159R by post 118R. As a user moves thumb block 171 forward, slide bar 172 also moves forward. However, blade assembly 110 is prevented from moving forward since top and bottom ridges 124 and 126 respectively bear against inner cutout portions 1551 and 1651 of rear locking features 154R and 164R. Accordingly, since tab 179R is held in place by post 118R, the tension in springs 178 increases. As slide bar 172 moves forward, angled portion 173R pushes against pushing portion 183 of lever 180R, which in turn causes pushing portion 184 to push against top ridge 124, as indicated by arrow 190 in FIG. 5A. (By configuring top ridge 124 to extend beyond the edge of locking member 120 and pushing portion 184 to push against the outer portion of top ridge 124, increased mechanical advantage may be provided in some embodiments.) This in turn causes locking member 120 to rotate towards the sliding position as indicated by arrow 191. As shown in FIG. 5B, once top ridge 124 is aligned with slot 152 (and locking member 120 is thus the sliding position), blade assembly 110 is free to move relative to handle assembly 140, and the tension in springs 178 causes tab 179R to impart a forward impulse to post 118R (and thus blade assembly 110) as indicated by arrow 192. The momentum imparted to blade assembly 110 is sufficient for blade assembly 110 to move to the extended position.

As best seen in FIG. 6A, as blade assembly 110 moves toward the extended position, bottom ridge 126 slides within slot 162 as indicated by arrow 193. As blade assembly 110 reaches the extended position, bottom ridge 126 is contacted by the outer end of spring arm 128F and urged out of alignment with slot 162 as indicated by arrow 194 (see FIG. 6B), such that bottom ridge 126 is rotated to engage locking features 164F (likewise, top ridge 124 of locking member 120 is rotated out of alignment with slot 152 to engage locking features 154F).

To move blade assembly 110 from the extended position to the retracted position, the user moves thumb block 171 (and thus slide bar 172) rearward. As slide bar 172 moves rearward, the tension in springs 178 increases and angled portion 173F pushes against pushing portion 183 of lever 180F, which in turn causes pushing portion 184 to push against top ridge 124. Once locking member 120 is rotated out of engagement with locking features 154F and 164F, the tension in springs 178 causes tab 179F to impart a rearward impulse to post 118F, which moves blade assembly 110 to the retracted position. As blade assembly 110 reaches the retracted position, bottom ridge 126 is contacted by the outer end of spring arm 128R and urged out of alignment with slot 162 such that bottom ridge 126 is rotated to engage locking features 164R (likewise, top ridge 124 of locking member 120 is rotated out of alignment with slot 152 to engage locking features 154R).

FIG. 9 shows an exploded view of a knife 200 according to another embodiment. according to other embodiments of the invention. Knife 200 is similar to knife 100, and where applicable, corresponding features thereof are indicated using corresponding reference characters (for example, for knife 200, reference characters for features corresponding to those in knife 100 have the form 2xx in place of 1xx). To avoid unnecessary repetition, features of knife 200 which are the same as those described above will not be described again.

Actuating assembly 270 is substantially the same as actuating assembly 170, except that there are no slide bar guides attached to the bottom side of slide bar 272. Instead, slide bar 272 is prevented from being pushed laterally by levers 280F and 280R by stop blocks 288F and 288R, as noted above. Levers 280F and 280R (generically referred to as lever 280, although they need not be identical) are shaped differently than levers 180F and 180R, as described below with reference to FIG. 13.

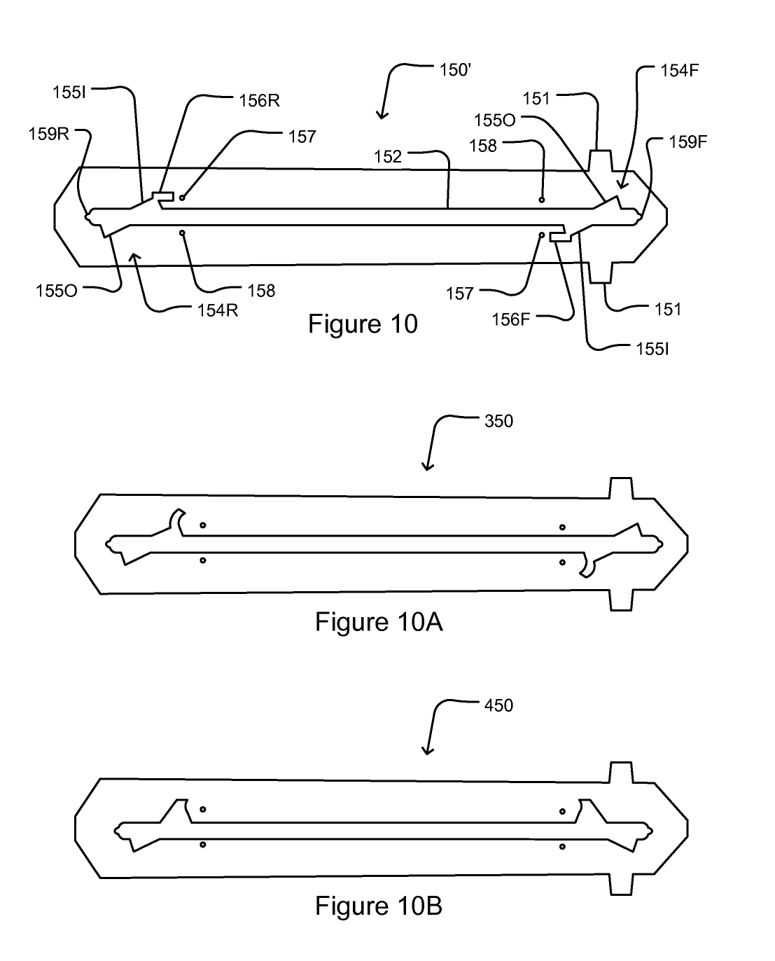

As shown in FIGS. 9 and 10, upper guide member 250 of knife 200 differs from that of knife 100 in that front and rear locking features 254F and 254R have lever recesses 155F and 155R adjacent thereto to accommodate levers 280F and 280R. Lever apertures 257 may be positioned differently with respect to locking features 254 to accommodate levers 280F and 280R. Upper guide member 250 also has a stop block mounting aperture 258 (instead of a guide slot as in upper guide member 150) across from each lever aperture 257 for mounting stop blocks 288F and 288R.

FIGS. 10A and 10B show upper guide members 350 and 450 according to other embodiments. Guide member 350 of FIG. 10A has lever recesses shaped to accommodate levers such as lever 380 of FIG. 13A or lever 380′ of FIG. 13B. Guide member 450 of FIG. 10B has locking features which are mirror images of one another. In such an embodiment, biasing is provided by mechanisms which urge the locking member to rotate in opposite directions in the extended and retracted positions.

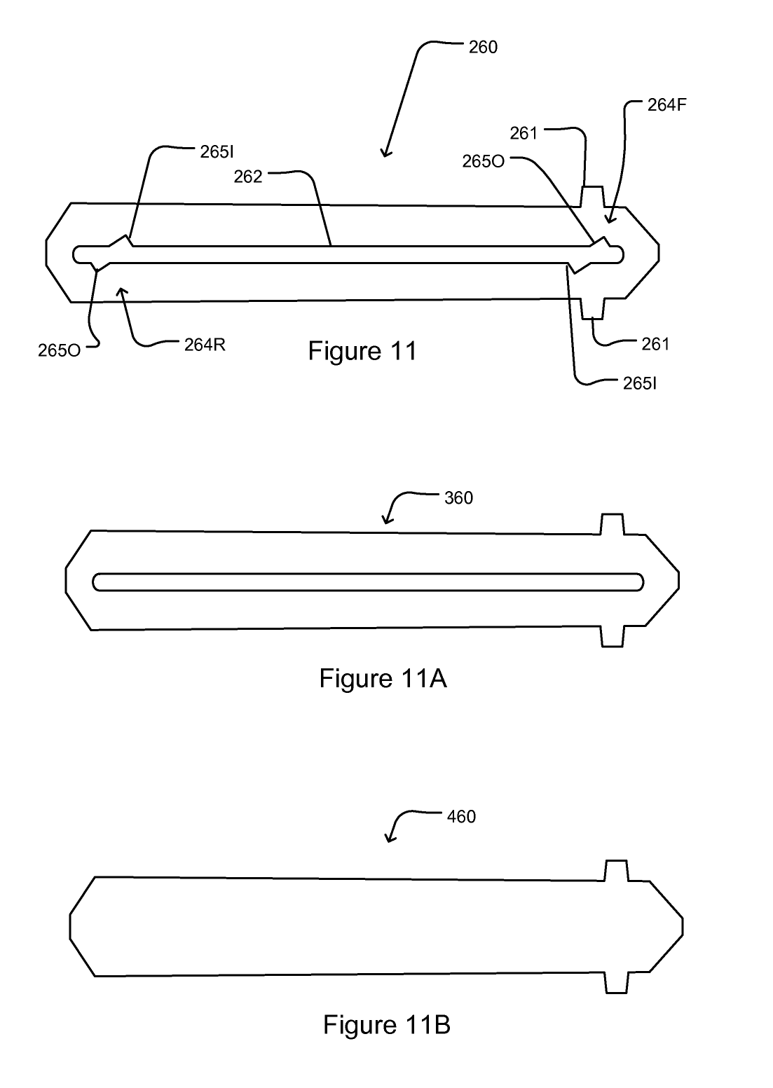

As shown in FIGS. 9 and 11, lower guide member 260 of knife 200 is substantially similar to that of knife 100, except that no spring arms are mounted on lower guide member 260. Biasing is provided by spring 229 in knife 200, as described below.

FIGS. 11A and 11B show lower guide members 360 and 460 according to other embodiments. Guide member 360 of FIG. 11A lacks locking features. Guide member 460 of FIG. 11B lacks a slot.

Tang portion 214 of blade assembly 210 has a spring recess 217 adjacent aperture 216, and locking member 220 has a corresponding recess 229A (see FIG. 12A) configured to accept coil spring 229. Coil spring 229 is positioned to exert a torque to urge locking member 220 toward the locking position.

As shown in FIGS. 9 and 12, top and bottom ridges 224 and 226 of locking member 220 have about the same thickness as upper and lower guide members 250 and 260.

FIG. 12B shows a locking member 320 according to another embodiment. Locking member 320 comprises a pair of posts 327 on opposite edges of each of the top and bottom sides of body 321.

As shown in FIGS. 9 and 13, body 282 of lever 280 has a sufficient thickness such that lever 280 extends sufficiently upward from upper guide member such that pushing portion 283 is contacted by angled portion 273 of slide bar 272 without extending up from body 282. Pushing portion 284 which rotates locking member 220 is bent downwardly and inwardly from body 282. In some embodiments, the bottom side of slide bar 272 may have cutout portions configured to accommodate sliding past levers 280.

Where a component (e.g. an assembly, device, etc.) is referred to above, unless otherwise indicated, reference to that component (including reference to a means) should be interpreted as including as equivalents of that component any component which performs the same function as the described component, including components which are not structurally equivalent to the disclosed structures which perform the function in the illustrated exemplary embodiments of the invention.

Unless the context clearly requires otherwise, throughout the description and the claims, the words “comprise,” “comprising,” and the like are to be construed in an inclusive sense, that is, in the sense of “including, but not limited to.” As used herein, the terms “connected,” “coupled,” or any variant thereof, means any connection or coupling, either direct or indirect, between two or more elements; the coupling or connection between the elements can be physical, logical, or a combination thereof. Additionally, the words “herein,” “above,” “below,” and words of similar import, shall refer to this document as a whole and not to any particular portions. Where the context permits, words using the singular or plural number may also include the plural or singular number respectively. The word “or,” in reference to a list of two or more items, covers all of the following interpretations of the word: any of the items in the list, all of the items in the list, and any combination of the items in the list.

While a number of exemplary aspects and embodiments have been discussed above, those of skill in the art will recognize certain modifications, permutations, additions and sub-combinations thereof. For example:

two or more locking members may be provided in the tang portion, with linkages connecting such that the locking members rotate in unison;

although the illustrated embodiments show locking members having generally cylindrical bodies, a locking member may have a body with a non-cylindrical shape, provided that the corresponding aperture is configured to permit rotation through at least enough of an angle for the locking protrusion(s) to engage the locking features;

the locking member does not necessarily need to extend through the tang portion, but instead could be rotatably mounted on one side of the tang portion

although the illustrated embodiments show the slide bar with angled portions on opposite sides thereof, in other embodiments the slide bar may angled portions on the same side, and the levers may mounted on same side of slot in upper guide member, and front and rear locking portions may be mirror images instead of rotated 180 degrees;

a different type of actuating assembly may be used to move the blade assembly and/or rotate the locking member.

It is therefore intended that the following appended claims and claims hereafter introduced are interpreted to include all such modifications, permutations, additions and sub-combinations as are within their true essence and scope.

What is claimed is:

1. Apparatus for locking an out the front knife having a blade assembly moveable with respect to a handle assembly between an extended position and a retracted position, the apparatus comprising:
a first guide member in the handle assembly, the first guide member having a first longitudinal slot defined therein, the first longitudinal slot having first front locking features at a forward portion thereof and first rear locking features at a rearward portion thereof; and
a locking member rotatably coupled to a tang portion of the blade assembly, the locking member having at least one locking protrusion thereon, wherein the locking member is rotatable between a sliding position wherein the locking protrusion is aligned with the first longitudinal slot and a locking position wherein the locking protrusion is not aligned with the first longitudinal slot, whereby the blade assembly is lockable in the extended position by rotating the locking member to the locking position such that the locking protrusion engages the first front locking features, and the blade assembly is lockable in the retracted position by rotating the locking member to the locking position such that the locking protrusion engages the rear locking features.

2. Apparatus according to claim 1 comprising one or more biasing members configured to urge the locking member toward the locking position when the blade assembly is in the extended position and when the blade assembly is in the retracted position.

3. Apparatus according to claim 2 comprising a second guide member having a second longitudinal slot defined therein, the second longitudinal slot having second front locking features at a forward portion thereof and second rear locking features at a rearward portion thereof, wherein the blade assembly is configured to be slidably received between the first and second guide members.

4. Apparatus according to claim 3 wherein the locking member comprises a body having thickness substantially the same as a thickness of the tang portion and a spacing between the first and second guide members, the body having a first side facing the first guide member and a second side facing the second guide member, the body having a first locking protrusion extending from the first side thereof and a second locking protrusion extending from the second side thereof.

5. Apparatus according to claim 4 wherein the one or more biasing members comprise a front spring arm and a rear spring arm coupled to the second guide member, the front spring arm configured to bear against the second locking protrusion to urge the locking member toward the locking position when the blade assembly is in the extended position, and the rear spring arm configured to bear against the second locking protrusion to urge the locking member toward the locking position when the blade assembly is in the retracted position.

6. Apparatus according to claim 4 wherein the first locking protrusion comprises a ridge extending outwardly past a circumference of the body.

7. Apparatus according to claim 5 wherein the second locking protrusion comprises a ridge having a height greater than a thickness of the second guide member.

8. Apparatus according to claim 2 wherein the one or more biasing members comprise a coil spring received in a recess in the tang portion and a corresponding recess in the locking member.

9. Apparatus according to claim 2 comprising a front lever configured to selectively urge the locking member toward the sliding position when the blade assembly is in the extended position a rear lever configured to selectively urge the locking member toward the sliding position when the blade assembly is in the retracted position.

10. Apparatus according to claim 9 wherein the front lever and rear levers pivotally mounted to the first guide member at locations inward of the front locking features and the rear locking features, and the front locking features and the rear locking features each comprise an inner cutout portion and an outer cutout portion, wherein the inner cutout portions are configured to accommodate pushing portions of the front and rear levers.

11. Apparatus according to claim 1 wherein the first guide member comprises a pair of opposed side tabs extending laterally therefrom near a front thereof, and wherein the blade assembly of the knife comprises a blade portion substantially as wide as the handle assembly excluding the side tabs.

12. Apparatus according to claim 11 comprising a second guide member comprising a second pair of opposed side tabs extending laterally therefrom near a front thereof, and a pair of side spacers positioned between the side tabs of the first and second guide members.

13. Apparatus according to claim 12 wherein the tang portion comprises a pair of opposed side portions which are configured to abut the side spacers when the blade assembly is in the extended position.

14. Apparatus according to claim 9 comprising an actuating assembly configured to move the blade assembly between the extended position and the retracted position, the actuating assembly comprising a thumb block operable by a user, the thumb block connected to a slide bar with angled portions configured to bear against the front and rear levers to selectively cause the front and rear levers to urge the locking member to the sliding position.

15. A method for locking an out the front knife having a blade assembly moveable with respect to a handle assembly between an extended position and a retracted position, the blade assembly comprising blade at a front thereof and a tang portion at a rear thereof, the method comprising:
providing a first guide member in the handle assembly, the first guide member having a first longitudinal slot defined therein, the first longitudinal slot having first front locking features at a forward portion thereof and first rear locking features at a rearward portion thereof;
providing a locking member rotatably coupled to a tang portion of the blade assembly, the locking member having at least one locking protrusion thereon, wherein the locking member is rotatable between a sliding position wherein the locking protrusion is aligned with the first longitudinal slot and a locking position wherein the locking protrusion is not aligned with the first longitudinal slot;
when the blade assembly is in the extended position, rotating the locking member to the locking position such that the locking protrusion engages the first front locking features to lock the blade assembly in the extended position; and,
when the blade assembly is in the retracted position, rotating the locking member to the locking position such that the locking protrusion engages the rear locking features to lock the blade assembly in the retracted position.

16. A method according to claim 15 comprising urging the locking member toward the locking position when the blade assembly is in the extended position and when the blade assembly is in the retracted position.

17. A method according to claim 16 comprising providing a second guide member having a second longitudinal slot defined therein, the second longitudinal slot having second front locking features at a forward portion thereof and second rear locking features at a rearward portion thereof, wherein the blade assembly is configured to be slidably received between the first and second guide members.

18. A method according to claim 17 wherein urging the locking member comprises providing a front spring arm adjacent the first or second front locking features and a rear spring arm adjacent the first or second rear locking features.

19. A method according to claim 16 wherein urging the locking member comprises providing a coil spring received in a recess in the tang portion and a corresponding recess in the locking member.

20. A knife comprising:
a handle assembly comprising an upper guide member and a lower guide member oriented generally parallel to each other and separated by a first distance, each of the upper and lower guide members having a longitudinal slot defined therein, the upper and lower slots being generally aligned with each other, and each of the upper and lower slots having front locking features at a forward portion thereof and rear locking features at a rear portion thereof; and,
a blade assembly comprising a blade having one ore more cutting edges at a forward portion thereof and a tang portion at a rear portion thereof, the blade assembly moveable inwardly and outwardly with respect to the handle assembly between an extended position wherein the one or more cutting edges are exposed and a retracted position wherein the one or more cutting edges are within the handle assembly, the tang portion having a thickness no greater than the first distance and comprising one or more tang protrusions extending from opposite sides thereof such that the tang portion is slidably received between the upper and lower guide members with the tang protrusions extending into the slots, the blade assembly comprising a locking member rotatably received in an aperture in the tang portion, the locking member comprising a body having a thickness no greater than the first distance and one or more locking protrusions extending from opposite sides thereof, the locking member rotatable between a sliding position wherein the locking protrusions are aligned with the tang protrusions and the slots and a locking position wherein the locking protrusions are not aligned with the tang protrusions and the slots,
wherein when the blade assembly is in the extended position the locking protrusions are adjacent to the front locking features such that the locking member is rotatable to engage the front locking features with the locking protrusions to lock the blade assembly in the extended position,
and wherein when the blade assembly is in the retracted position the locking protrusions are adjacent to the rear locking features such that the locking member is rotatable to engage the rear locking features with the locking protrusions to lock the blade assembly in the retracted position.
